(19) United States
(12) Patent Application Publication
(10) Pub. No.: US 2012/0316801 A1
(43) Pub. Date: Dec. 13, 2012

(54) EMULATOR AND EMULATING METHOD OF ELECTRICAL RESPONSE OF BIOLOGICAL TISSUE

(76) Inventor: Robert RIEGER, Kaohsiung (TW)

(21) Appl. No.: 13/156,639

(22) Filed: Jun. 9, 2011

(51) Int. Cl. G06F 19/00

(52) U.S. Cl. 702/57

(57) ABSTRACT

An emulator of an electrical response of a biological tissue includes an artificial nerve module, a DAC module, and a mesh resistor circuit. The artificial nerve module includes a plurality of microcontrollers coupled to each other, and each of the microcontrollers has at least one control end and at least one voltage signal output portion providing a total of at least two voltage signal output ends. The DAC module includes DACs corresponding to the at least two voltage signal output ends, and each of the DACs is coupled to the voltage signal output end to output a node voltage. The mesh resistor circuit includes a plurality of first resistors and second resistors corresponding to each other, each of the first resistors and each of the second resistors corresponding to each other define a node, and the node is used to accept the node voltage.

### BACKGROUND

1. Technical Field

The present disclosure relates to an emulator, and more particularly to an emulator and an emulating method of an electrical response of a biological tissue.

2. Related Art

Advanced circuits and systems for the recording of small physiological signals such as nerve signals (ENG), surface muscle signals (sEMG) are currently under research and development in laboratories worldwide. The practical recording of the minute signals in the microvolt range poses severe challenges. The performance evaluation of new electronic circuits for the recording of ENG may be challenging, as in the natural nervous system many axons are bundled together, so that only compound traffic can be detected when using the common non-invasive cuff electrodes. The use of multi-electrode systems for signal averaging and for velocity selective recording has recently come into the focus of research interest for both, ENG and sEMG recording. Typically, some in vitro experiments are required to evaluate new recording approaches which necessitate the explantation of nerve from a sacrificed animal, artificial nerve stimulation and a complex recording setup or volunteers requiring consent procedures and highly trained medical staff.

Referring to FIG. 1 and FIG. 2, FIG. 1 and FIG. 2 illustrate a conventional test setup using frog nerve.

A conventional nerve signal recording setup 5 includes a contact cuff (MEC) 50 in the saline bath 52, an amplifier array 51, a stimulator 53, an amplifier 54 and a computer device 55. Two action potentials (for example, a nerve signal S1 and a nerve signal S2) with different velocities and their electro neurogram as recorded by an eleven contact cuff 50 connected to a suitable amplifier array 51. The electrode cuff 50 is wrapped around the nerve 60, so that the nerve signals travel through the insulating cuff 50 and the resulting potential are recorded between embedded electrodes. By using several recording electrode pairs inside a length of cuff 50 and a suitable amplifier array 51, the propagation of the signals can be observed in the computer device 55. The setup 5 is gaining interest in current research for the discrimination of action potentials according to their propagation velocity and direction.

A nerve recording using the setup of FIGS. 1 and 2 is shown in FIG. 3. FIG. 3 shows nerve recordings of electrically evoked potentials. Wherein, a black bar to the right shows the amplitude scale: 50 uV.

As mentioned above, this test recording may be very difficult to obtain as a suitable nerve 60 must be explanted from an animal, the saline bath 52 must match the properties of body fluid, the temperature and acidity must be kept realistic, the nerve 60 must not be damaged during setup, and many problems more. This setup may be elaborate and error prone.

### SUMMARY

Accordingly, the present disclosure provides an emulator and an emulating method of an electrical response of a biological tissue.

The present disclosure provides an emulator of an electrical response of a biological tissue, which comprises an artificial nerve module, a digital to analog converter (DAC) module, and a mesh resistor circuit. The artificial nerve module comprises a plurality of microcontrollers coupled to each other, and each of the microcontrollers has at least one control end and at least one voltage signal output portion providing a total of at least two voltage signal output ends. The DAC module comprises DACs corresponding to the at least two voltage signal output ends, and each of the DACs is coupled to the voltage signal output end to output a node voltage. The mesh resistor circuit comprises a plurality of first resistors and second resistors corresponding to each other, each of the first resistors and each of the second resistors corresponding to each other define a node, and the node is used to accept the node voltage.

The present disclosure also provides an emulating method of an electrical response of a biological tissue, which comprises: providing an artificial nerve module comprising a plurality of microcontrollers coupled to each other, in which each of the microcontrollers has at least one control end and at least one voltage signal output portion providing a total of at least two voltage signal output ends; providing a DAC module comprising DACs corresponding to the at least two voltage signal output ends, in which each of the DACs is coupled to the voltage signal output end to output a node voltage; and providing a mesh resistor circuit comprising a plurality of first resistors and second resistors corresponding to each other, in which each of the first resistors and each of the second resistors define a node, and the node is used to accept the node voltage.

### BRIEF DESCRIPTION OF THE DRAWINGS

The present disclosure will become more fully understood from the detailed description given herein below for illustration only, and thus are not limitative of the present disclosure, and in which:

FIG. 1 illustrates a conventional test setup using frog nerve;

FIG. 2 illustrates a conventional test setup using frog nerve;

FIG. 3 shows nerve recordings of electrically evoked potentials;

FIG. 4 is a schematic view of an emulator of an electrical response of a biological tissue according to an embodiment of the present disclosure;

FIG. 5 is a schematic view of a mesh resistor circuit of an emulator of an electrical response of a biological tissue according to an embodiment of the present disclosure;

FIG. 6A shows two time-delayed TMAPs modeled using a mathematical function;

FIG. 6B shows an example of two overlapping TMAPs of different velocities;

FIG. 7 is a schematic view of a mesh resistor circuit of an emulator of an electrical response of a biological tissue according to another embodiment of the present disclosure;

FIG. 8 is a flow chart of an emulating method of an electrical response of a biological tissue according to an embodiment of the present disclosure;

FIG. 9 is a flow chart of setting a position sequence of microcontrollers according to an embodiment of the present disclosure; and

FIG. 10 is a schematic view of an operation loop of each microcontroller during startup according to an embodiment of the present disclosure.

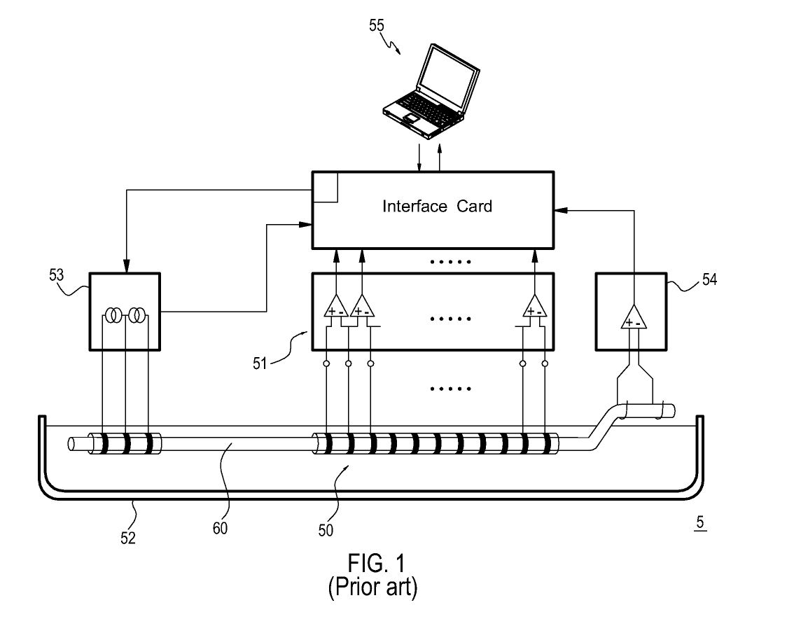

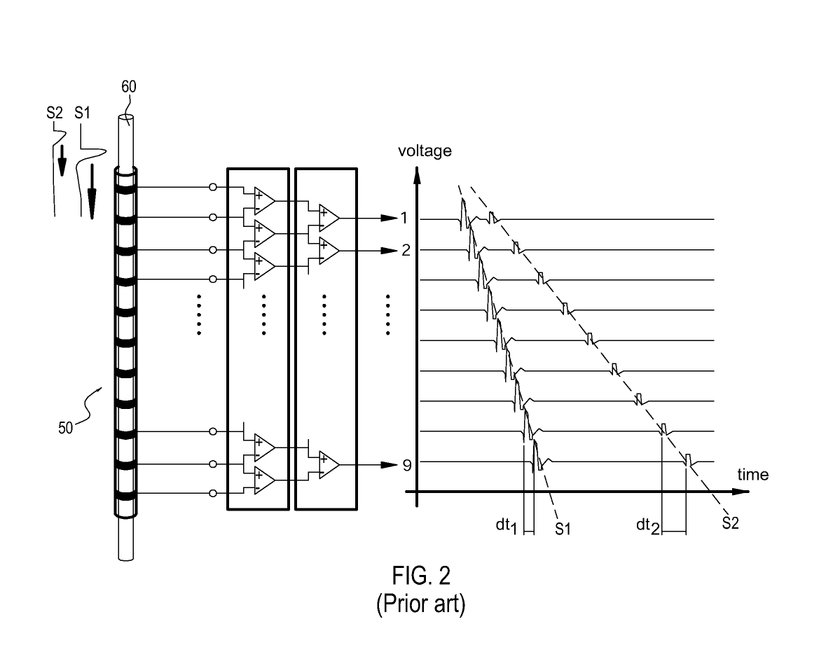

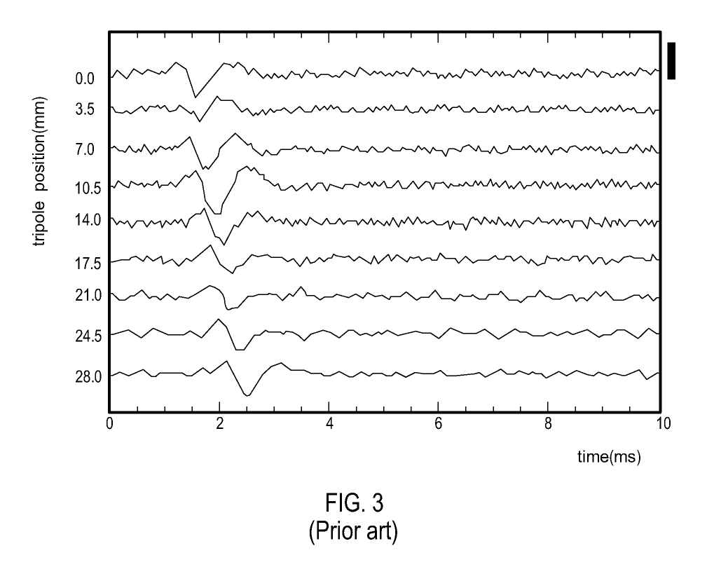

### DETAILED DESCRIPTION

In order to make the aforementioned features and characteristics of the present disclosure more comprehensible, embodiments accompanied with figures are described in detail below.

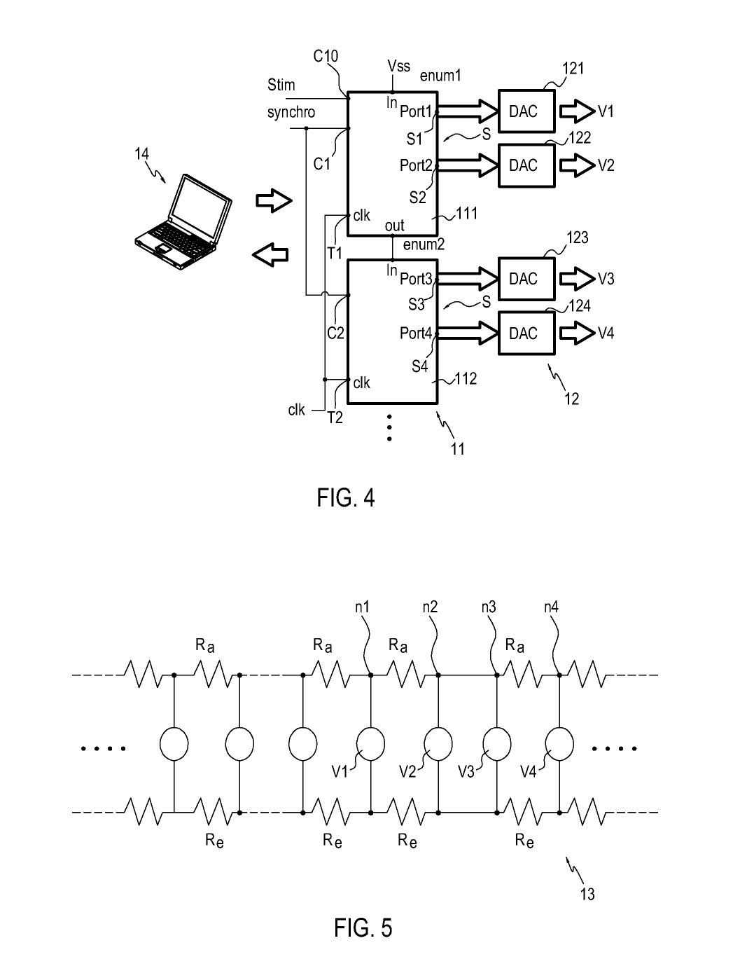

Referring to FIG. 4 and FIG. 5, FIG. 4 is a schematic view of an emulator of an electrical response of a biological tissue according to an embodiment of the present disclosure; and FIG. 5 is a schematic view of a mesh resistor circuit of an emulator of an electrical response of a biological tissue according to an embodiment of the present disclosure.

An emulator of an electrical response of a biological tissue (called the emulator for short below) includes an artificial nerve module 11, a DAC module 12, and a mesh resistor circuit 13. Preferably, the emulator further includes a monitoring computer 14 electrically connected to the artificial nerve module 11.

The artificial nerve module 11 includes a plurality of microcontrollers (for example, PIC microcontrollers) coupled to each other. In this embodiment, only a first microcontroller 111 and a second microcontroller 112 are used for illustration. However, during actual application, two or more microcontrollers are also applicable, and the number of the microcontrollers is not limited thereto. In addition, each of the microcontrollers includes programmable characteristics.

Each of the microcontrollers has at least one control end and at least one voltage signal output portion S providing a total of at least two voltage signal output ends. For example, the first microcontroller 111 has at least one first control end C1, a first stimulation input end C10, and at least two voltage signal output ends S1 and S2. The second microcontroller 112 has at least one second control end C2, a second stimulation input end (not shown), and at least two voltage signal output ends S3 and S4. The first control end C1 and the second control end C2 may be coupled to each other. A user may use the monitoring computer 14 to input a control instruction to the at least one control end; or the user may use the monitoring computer 14 to select and input a preset emulating scenario instruction to the first stimulation input end C10 or the second stimulation input end.

In this embodiment, the at least one control end includes the first control end C1 and the second control end C2. By using the first control end C1 and the second control end C2 and through the monitoring computer 14, the user can perform relevant emulating control on the first microcontroller 111 and the second microcontroller 112, or perform sequence setting between the microcontrollers. Alternatively, the user only performs the relevant emulating control on only one of the microcontrollers through the monitoring computer 14.

The DAC module 12 includes DACs 121-124 corresponding to the voltage signal output ends S1-S4. For example, each of the DACs is used to convert a digital waveform signal (for example, 8 bits) output by the voltage signal output end corresponding to the DAC into an analog waveform signal. Specifically, the DACs 121-124 are coupled to the corresponding voltage signal output ends S1-S2, so as to output node voltages V1-V4 respectively.

In this embodiment, the mesh resistor circuit 13 forms a one-dimensional (1D) model mesh resistor circuit. The 1D model mesh resistor circuit can be used to emulate a nerve cell axon (for example, ENG). The mesh resistor circuit 13 includes a plurality of first resistors Ra and second resistors Re corresponding to each other. Each of the first resistors Ra and each of the second resistors Re corresponding to each other define a node n, and the node n is used to accept a corresponding node voltage. For example, the node voltages V1-V4 output by the DACs 121-124 of FIG. 4 are applied to the nodes of FIG. 5 respectively. For example, in FIG. 5, the node voltage V1 corresponds to a node n1, the node voltage V2 corresponds to a node n2, the node voltage V3 corresponds to a node n3, and the node voltage V4 corresponds to a node n4.

Each of the microcontrollers further has a power supply input end (for example, a power supply input end Vss of the first microcontroller 111 of FIG. 4) to be used as a working voltage. The microcontrollers are coupled to each other, so that the first and the second microcontrollers may share the same power supply. In addition, each of the microcontrollers further has a time signal end. For example, the first microcontroller 111 has a first time signal end T1, and the second microcontroller 112 has a second time signal end T2. The first time signal end T1 and the second time signal end T2 are coupled to each other.

In the embodiment, the transmembrane potential of the action potential (TMAP) is approximated using a mathematical function. This allows generating potentials of the desired characteristics. A function approximating the TMAP is provided as below:

VTMAP=A*t.*exp(−B*t)

where A and B are fitting parameters and t is the time vector.

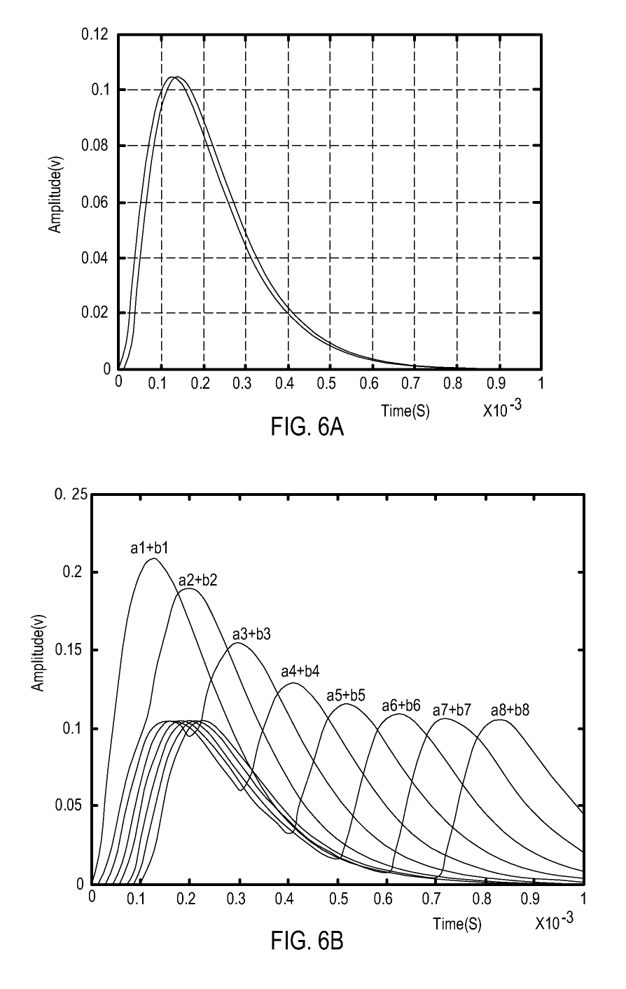

Referring to FIG. 6A and FIG. 6B, FIG. 6A shows two time-delayed TMAPs modeled using a mathematical function. FIG. 6B shows an example of two overlapping TMAPs of different velocities (TMAP summation).

Two typical TMAPs generated using the above function are shown in FIG. 6A and FIG. 6B. A time delay is introduced between the TMAPS. This models the delay that the amplifiers in a MEC record due to the finite action potential velocity. For typical cuff electrode pitches of 1.5 mm and AP velocity between 20 m/s and 100 m/s a delay of 75 us-15 us results. The amplitude course of the potential is generated by a microcontroller (for example, a PIC microcontroller). The digital waveform output is converted to a voltage signal (for example, the node voltages V1-V4) which represents the local membrane voltage within the recording cuff. External digitally-controlled voltage sources are used for this purpose.

The circuit in FIG. 5 is a 1D model of a myelinated nerve fibre in a cuff FIG. 5 is a simplified model, because the cuff is assumed to be an integer number of inter-nodal lengths long, with nodes at the ends. However, it is of sufficient accuracy to deliver useful results. Over the cuff length, the resistance of the axoplasm (i.e. the intracellular resistance) is Ra and the extracellular resistance is Re. Re and Ra are divided into n inter-nodal sections by nodes 0, 1, 2, . . . , n. Resistance Ra, the intracellular resistance per section, is assumed to be uniform. Resistance Re, the extracellular resistance per section, may vary around an average value, representing cuff interface non-idealities. Assuming that the resistance outside the confines of the cuff is negligible, and therefore the external end nodes are both shown grounded. The voltage generators (for example, the node voltages V1-V4) represent the potential differences across the membrane at the nodes of Ranvier and are generated by the DACs (for example, DAC 121-124). Each TMAP is delayed between the nodes by z/v, where v is the propagation velocity. If more than one nerve fibre is embedded in the cuff, this is represented by a change in the resistances Ra and Re and summation of the individual TMAP templates at the nodes. The emulator back-end for generating the TMAP voltages is shown in FIG. 4.

To provide more than two recording nodes, additional microcontrollers (for example, another first microcontroller 111 and the second microcontroller 112) can be hooked to the chain. A synchronization signal is used to time-lock the microcontrollers. The microcontrollers are informed about the number of AP and their properties during an initial start-up phase. The microcontrollers then calculate the resulting membrane potential for a given period of time. The data are stored in a table and played back during emulation time. Most importantly, in a natural bundle of nerve, more than a single action potential travels at any given time. Therefore, several TMAP with different velocities and amplitudes will be generated and superimposed in software running on the microcontrollers. Additionally, noise can be generated to set a realistic signal-to-noise ratio (SNR). Stimulation artifacts and interference break-through may also be emulated.

The voltages (for example, the node voltages V1-V4) generated by the DACs feed into the cuff interface model shown in FIG. 5. Thus, an amplifier array using the emulator connects to the free ends of resistors Re. In a later refinement of the model capacitances can be added to provide complex interface impedance.

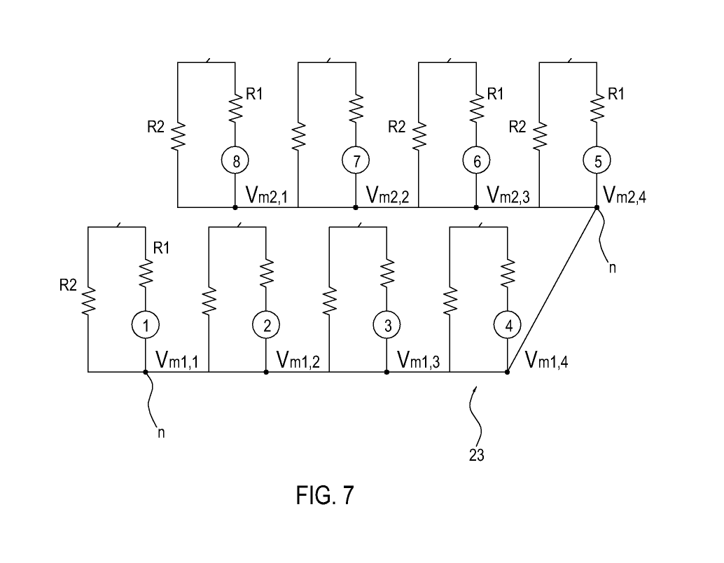

Referring to FIG. 4 and FIG. 7, FIG. 7 is a schematic view of a mesh resistor circuit of an emulator of an electrical response of a biological tissue according to another embodiment of the present disclosure.

In this embodiment, a mesh resistor circuit 23 forms a two-dimensional (2D) model mesh resistor circuit. The 2D model mesh resistor circuit may be used to emulate a tissue surface (for example, sEMG). The mesh resistor circuit 23 includes a plurality of first resistors R1 and second resistors R2 corresponding to each other. Each of the first resistors R1 and each of the second resistors R2 corresponding to each other define a node n, and the node n is used to accept a corresponding node voltage.

The potential on the surface of the body is emulated using the setup shown in FIG. 7. The microcontroller outputs are enumerated as shown by the digits inside the voltage source symbol. Resistors R1 and R2 (for example, the first resistor R1 and the second resistor R2) set the output resistance of the voltage generators (and thus the emulated tissue resistance between electrodes) and also form a voltage divider to scale down the emulated surface potential from the higher amplitude level generated by the DAC. The structure can be expanded in both directions as required by adding more microcontrollers to the chain. During enumeration, information of the dimensional layout is transmitted to each microcontroller in the form of two numbers (x, y). Knowing its own enumerator, the microcontroller (for example, the first microcontroller 111 or the second microcontroller 112) determines its position within the matrix and calculates its output voltage dynamics accordingly.

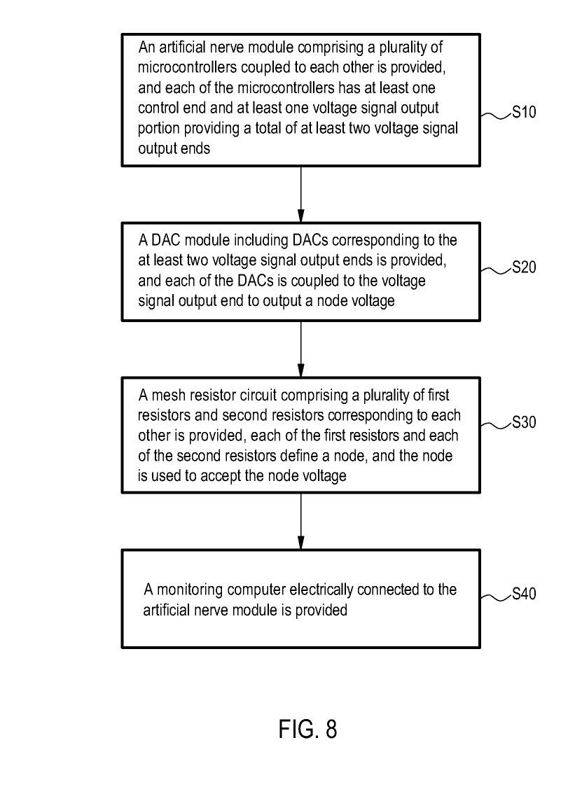

Referring to FIG. 8, FIG. 8 is a flow chart of an emulating method of an electrical response of a biological tissue according to an embodiment of the present disclosure.

For the sake of brevity, an emulating method of an electrical response of a biological tissue (called the emulating method for short below) is illustrated with reference to FIG. 4 and FIG. 5 for better understanding (relevant technical characteristics are not repeated herein). The emulating method includes the following steps.

An artificial nerve module comprising a plurality of microcontrollers coupled to each other is provided, and each of the microcontrollers has at least one control end and at least one voltage signal output portion providing a total of at least two voltage signal output ends (Step S10).

A DAC module including DACs corresponding to the at least two voltage signal output ends is provided, and each of the DACs is coupled to the voltage signal output end to output a node voltage (Step S20).

A mesh resistor circuit comprising a plurality of first resistors and second resistors corresponding to each other is provided, each of the first resistors and each of the second resistors define a node, and the node is used to accept the node voltage (Step S30).

Preferably, the emulating method further includes: A monitoring computer electrically connected to the artificial nerve module is provided (Step S40).

In Step S10, an artificial nerve module 11 of a plurality of microcontrollers (for example, a first microcontroller 111 and a second microcontroller 112) coupled to each other is provided. Each of the microcontrollers has at least one control end and at least one voltage signal output portion providing a total of at least two voltage signal output ends. For example, the first microcontroller 111 has at least one first control end C1, a first stimulation input end C10, and at least two voltage signal output ends S1 and S2. The second microcontroller 112 has at least one second control end C2, a second stimulation input end, and at least two voltage signal output ends S3 and S4. The first control end C1 and the second control end C2 may be coupled to each other. A user may use the monitoring computer 14 to input a control instruction to the at least one control end; or the user may use the monitoring computer 14 to select and input a preset emulating scenario instruction to the first stimulation input end C10 or the second stimulation input end.

In Step S20, a DAC module 12 including DACs (for example, 121-124) corresponding to the at least two voltage signal output ends (for example, S1-S4) is provided. Each of the DACs is coupled to the voltage signal output end to output a node voltage. Specifically, the DACs 121-124 are coupled to the corresponding voltage signal output ends S1-S4, so as to output node voltages V1-V4 respectively.

In Step S30, a mesh resistor circuit (for example, a 1D model mesh resistor circuit 13 illustrated by FIG. 5; or a 2D model mesh resistor circuit 23 illustrated by FIG. 7) including a plurality of first resistors and second resistors corresponding to each other is provided. Each of the first resistors and each of the second resistors define a node n, and the node n is used to accept the node voltage. The 1D model mesh resistor circuit can be used to emulate a nerve cell axon; and the 2D model mesh resistor circuit can be used to emulate a tissue surface.

In Step S40, a monitoring computer 14 electrically connected to the artificial nerve module 11 is provided. Specifically, the monitoring computer 14 may include a keyboard and a screen. For example, the keyboard can be used by the user to input a control instruction, a preset emulating scenario instruction, or an instruction for setting a sequence between the microcontrollers; and the screen can be used by the user to view an emulating image (for example, FIG. 6A and FIG. 6B).

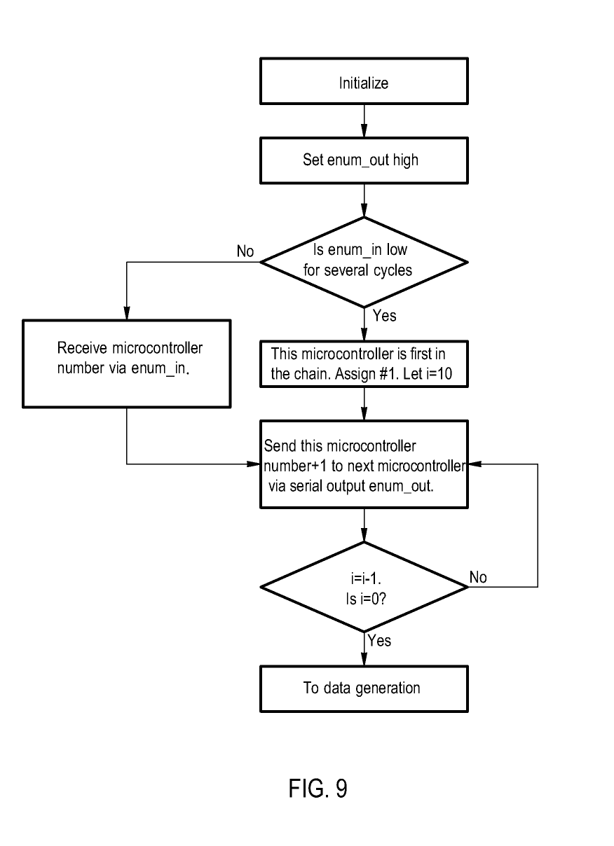

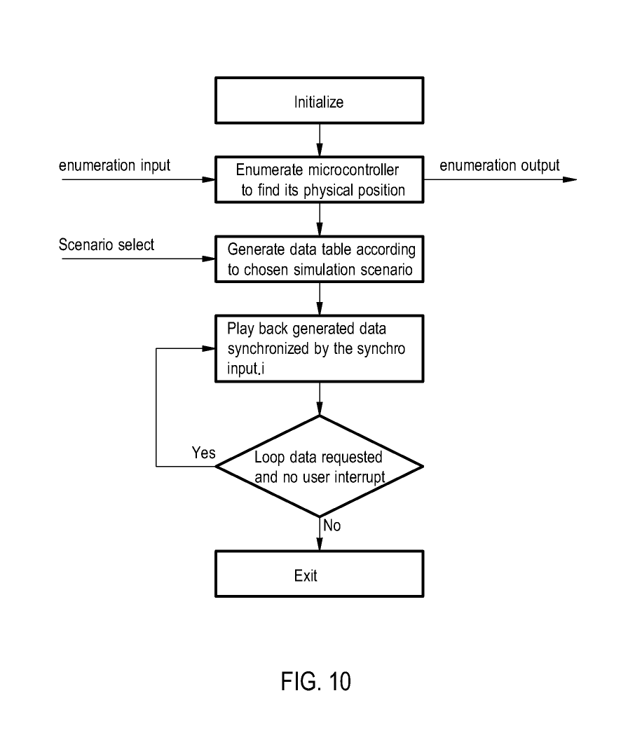

Referring to FIG. 4, FIG. 9, and FIG. 10, FIG. 9 is a flow chart of setting a position sequence of microcontrollers according to an embodiment of the present disclosure; and FIG. 10 is a schematic view of an operation loop of each microcontroller during startup according to an embodiment of the present disclosure.

To find the position of the microcontroller in the chain, an enumeration sequence is performed on startup. In this way, the chain can be extended easily to connect more microcontrollers. Each microcontroller can be programmed with the identical program code. Each microcontroller enum_out output connects to the following microcontroller enum_in input as shown in FIG. 4. Only the first microcontroller 111 enum_in connects to Vss. As shown in FIG. 9, each microcontroller sets its enum_output to high on startup. Therefore, only the first microcontroller 111 in the chain detects its enum_in to be low. It assigns itself the number #1 and passes the next higher number to the next microcontroller until all microcontrollers are enumerated. Also, additional parameters can be passed in this way to flexibly adjust parameters such as emulated electrode distance. The program then generates the data table according to the state of further input ‘Scenario select’. This is shown in FIG. 10. After all microcontrollers have prepared the data table, the output is timed by an external synchronizing clock. The data is played back and the playback can be repeated as desired.

If a stimulation input (‘stim’ in FIG. 4) is provided and artificial stimulation scenario is selected, the microcontrollers begin data output when the stim input C10 exceeds a predefined threshold (usually the digital ‘high’ level). Synchronized travelling action potentials (APs) can then be generated together with an artificial stimulation artifact if desired.

Moreover, other pre-defined scenarios may provide as below:

a. The number of AP travelling can be selected in several settings from ‘single’ (one AP only) to ‘many’ (realistic representation of naturally occurring traffic).

b. The range of AP velocities can be selected in different bands. This represents different types of nerve and different artificial stimulation modes.

c. Different ‘stimulation’ patterns can be selected.

d. Background activity can be added on top of stimulated activity.

e. Noise is added to the signal to set a realistic signal-to-noise ratio (SNR).

f. Stimulation artifacts and interference break-through are added for testing a device under realistic conditions.

In view of the above, the emulator and the emulating method of the electrical response of the biological tissue provided by the present disclosure have the following characteristics.

1. No nerve is required to be acquired from an animal body, in the present disclosure by using the plurality of microcontrollers of the emulator coupled to each other, an electrical response of nerves of a biological tissue can be emulated.

2. The emulator specifically includes emulation of the spatial property of the physical body (distribution of nodes and timing delays).

3. A number of low-cost, small-size microcontrollers are used for signal timing and generation of signal data.

4. The electrode tissue interface may be included as part of the emulator via passive resistors.

5. Nonetheless, the emulator has applications in areas which require only a voltage output instead of an emulated interface, e.g. in the testing of compression algorithm hardware implementations for ENG.

6. The emulator is scalable by linking additional microcontrollers in a chain which provides the desired number of electrode measurement points.

7. The emulator is microcontroller based and reprogrammable. It provides selectable pre-defined scenarios.

8. The emulated waveforms are based on AP templates rather than playing back pre-recorded data. It allows the emulator to be reconfigured easily to emulate different electrode arrangements and possibly shapes.

9. The disclosure reduces the cost, effort and time required for testing of new circuits and methods for nerve signal recording compared to some prior art. It removes the need for a physical in vivo/in vitro preparation. It also removes the need for the availability of a physical electrode (e.g. nerve cuff). It removes the need for specially trained medical staff to run a performance evaluation.

10. The disclosure improves the options available for testing new circuits and methods for nerve signal recording. It can generate different well-controlled scenarios, e.g. nerve traffic in a single direction, nerve traffic of specified velocity, predetermined noise levels, predetermined levels of artifact, etc.

In view of the above, implementation or embodiments of the technical solutions presented by the present disclosure to solve problems are described herein, which is not intended to limit the scope of implementation of the present disclosure. Equivalent modification and improvement in accordance with the claims of the present invention or made according to the claims of the present invention is covered by the claims of the present invention.

What is claimed is:

1. An emulator of an electrical response of a biological tissue, comprising:
an artificial nerve module, comprising a plurality of microcontrollers coupled to each other, wherein each of the microcontrollers has at least one control end and at least one voltage signal output portion providing a total of at least two voltage signal output ends;
a digital to analog converter (DAC) module, comprising DACs corresponding to the at least two voltage signal output ends, wherein each of the DACs is coupled to the voltage signal output end to output a node voltage; and
a mesh resistor circuit, comprising a plurality of first resistors and second resistors corresponding to each other, wherein each of the first resistors and each of the second resistors corresponding to each other define a node, and the node is used to accept the node voltage.

2. The emulator of an electrical response of a biological tissue according to claim 1, wherein the emulator further comprises a monitoring computer electrically connected to the artificial nerve module.

3. The emulator of an electrical response of a biological tissue according to claim 2, wherein each of the microcontrollers further has a stimulation input end, and the stimulation input end is used to receive a preset emulating scenario instruction selected by a user from the monitoring computer.

4. The emulator of an electrical response of a biological tissue according to claim 1, wherein the voltage signal output end is used to output a digital waveform.

5. The emulator of an electrical response of a biological tissue according to claim 1, wherein each of the microcontrollers further has a power supply input end

6. The emulator of an electrical response of a biological tissue according to claim 5, wherein each of the microcontrollers further has a time signal end.

7. The emulator of an electrical response of a biological tissue according to claim 1, wherein the mesh resistor circuit forms a one-dimensional (1D) model mesh resistor circuit.

8. The emulator of an electrical response of a biological tissue according to claim 1, wherein the mesh resistor circuit forms a two-dimensional (2D) model mesh resistor circuit.

9. An emulating method of an electrical response of a biological tissue, comprising:
providing an artificial nerve module comprising a plurality of microcontrollers coupled to each other, wherein each of the microcontrollers has at least one control end and at least one voltage signal output portion providing a total of at least two voltage signal output ends;
providing a digital to analog converter (DAC) module comprising DACs corresponding to the at least two voltage signal output ends, wherein each of the DACs is coupled to the voltage signal output end to output a node voltage; and
providing a mesh resistor circuit comprising a plurality of first resistors and second resistors corresponding to each other, wherein each of the first resistors and each of the second resistors define a node, and the node is used to accept the node voltage.

10. The emulating method of an electrical response of a biological tissue according to claim 9, further comprising:
providing a monitoring computer electrically connected to the artificial nerve module.
